(19) United States
(12) Patent Application Publication
(10) Pub. No.: US 2005/0044967 A1
(43) Pub. Date: Mar. 3, 2005

(54) Pneumatic tool accessory provided with means to monitor intensity of stress exerting thereon

(76) Inventor: Chin-Lung Tsai, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/647,316

(22) Filed: Aug. 26, 2003

(51) Int. Cl. G01L 5/04

(52) U.S. Cl. 73/862.07

(57) ABSTRACT

A pneumatic tool accessory is provided in a body thereof with a stress monitoring structure comprising a stress intensity control portion serving as a breaking point of the body, and a stress intensity monitor formed of a reference mark and an indicator mark. The indicator mark and the reference mark are separated from each other by the stress intensity control portion such that the indicator mark is aligned with the reference mark, and that the indicator mark is nonaligned with the reference mark at such time when the stress intensity control portion is deformed by a straining force exerting on the body.

### BACKGROUND OF THE INVENTION

1. Filed of the Invention

The present invention relates generally to a pneumatic tool, and more particularly to a pneumatic tool accessory which is provided with a stress monitoring structure for checking intensity of stress exerting thereon, so as to avert breakage or damage of the pneumatic tool accessory or workpiece.

2. Background of the Invention

The conventional pneumatic tool accessory is not provided with a stress monitoring structure by which the straining force exerting on the pneumatic tool accessory or workpiece is so checked as to prevent damage to the accessory itself or workpiece. The conventional pneumatic tool accessory, such as adaptor, connection rod, or the like, has a predetermined stress limit. However, the stress limit of a number of accessories of the same kind is apt to change in the event that they are made in batch, or that they are made by different materials or under different processing conditions. As a result, a user of the conventional pneumatic tool accessories is often in the dark as to the torsional limits of the accessories. Under such circumstances as described above, the conventional pneumatic tool accessories are prone to damage or breakage when they are put to work.

### SUMMARY OF THE INVENTION

The primary objective of the present invention is to provide a pneumatic tool accessory with a stress monitoring structure enabling a user of the pneumatic tool accessory to be aware of a fact that the strain exerting on the pneumatic tool accessory is about to reach a dangerous threshold.

In keeping with the principle of the present invention, the foregoing objective of the present invention is attained by the pneumatic tool accessory which is provided on a body thereof with a stress monitoring structure comprising a stress intensity control and a stress intensity monitor. The stress intensity control serves as a breaking point of the body of the pneumatic tool accessory while the stress intensity monitor is formed of a reference line and an indicator line which is aligned with the reference line. When the body of the pneumatic tool accessory is exerted on by and excessive straining force, the body tends to deform to result in nonalignment of the indicator line with the reference line.

The features and the advantages of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a perspective view of a first preferred embodiment of the present invention;

FIG. 2 shows a schematic plan view of the first preferred embodiment of the present invention;

FIG. 3 shows a schematic plan view of a deformation of the first preferred embodiment of the present invention;

FIG. 4 shows a perspective view of a second preferred embodiment of the present invention;

FIG. 5 shows a schematic plan view of the second preferred embodiment of the present invention; and

FIG. 6 shows a schematic plan view of a deformation of the second preferred embodiment of the present invention.

### DETAILED DESCRIPTION OF THE INVENTION

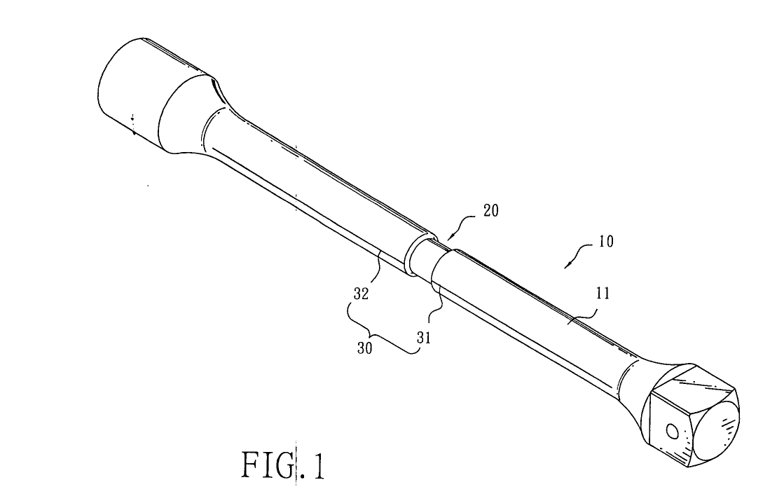

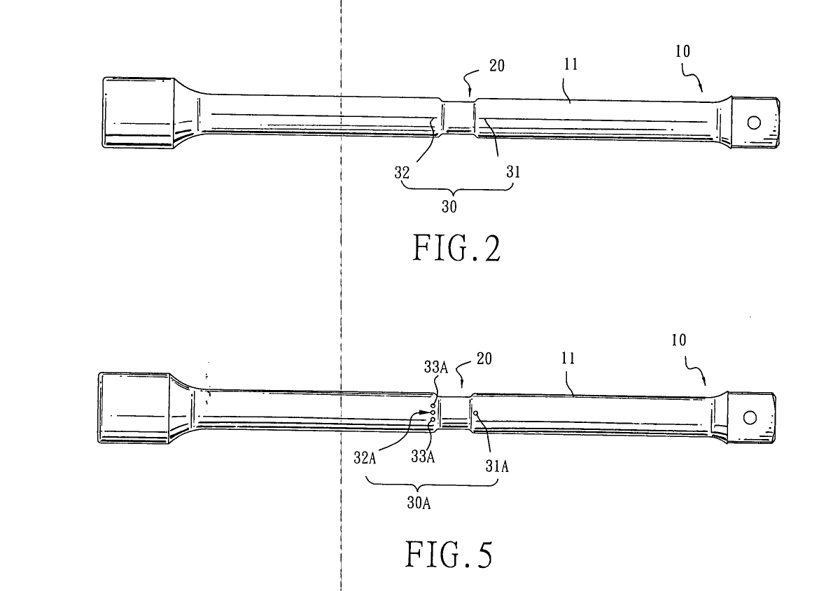

As shown in FIG. 1 and FIG. 2, a pneumatic tool accessory 10 of the present invention has a body 11 of a length. The body 11 is provided with a stress monitoring structure comprising a stress intensity control portion 20 and a stress intensity monitor 30. The stress intensity control portion 20 is a recessed portion smaller in outer diameter than the body 11. The recessed portion 20 is located at a midpoint of the body 11. The stress intensity monitor 30 is formed of an indicator line 31, and a reference line 32 which is separated from the indicator line 31 by the recessed portion 20. The indicator line 31 is aligned with the reference line 32, as shown in FIG. 2.

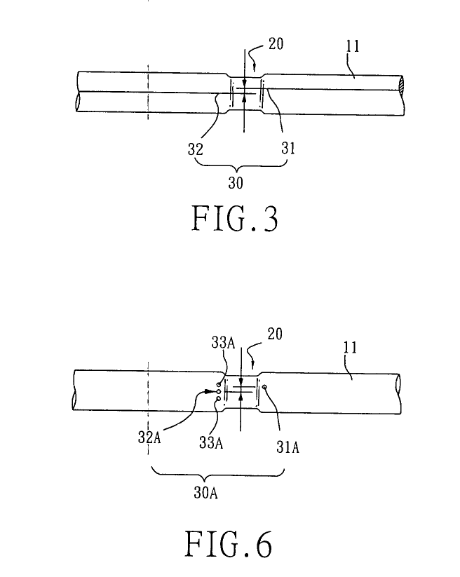

As illustrated in FIG. 3, the recessed portion 20 is caused to deform by a straining force exerting thereon, thereby resulting in nonalignment of the indicator line 31 with the reference line 32. Such nonalignment is indicative of an excessive stress produced in the body 11. If the excessive stress is allowed to persist, the stress intensity control portion 20 (the recessed portion) is bound to break. In another words, the stress intensity control portion 20 serves as a breaking point. As a result, the present invention is capable of preventing a damage to the pneumatic tool or workpiece. In addition, the present invention serves to minimize the occupational hazard, so as to enhance the safety of a worker using the pneumatic tool accessory.

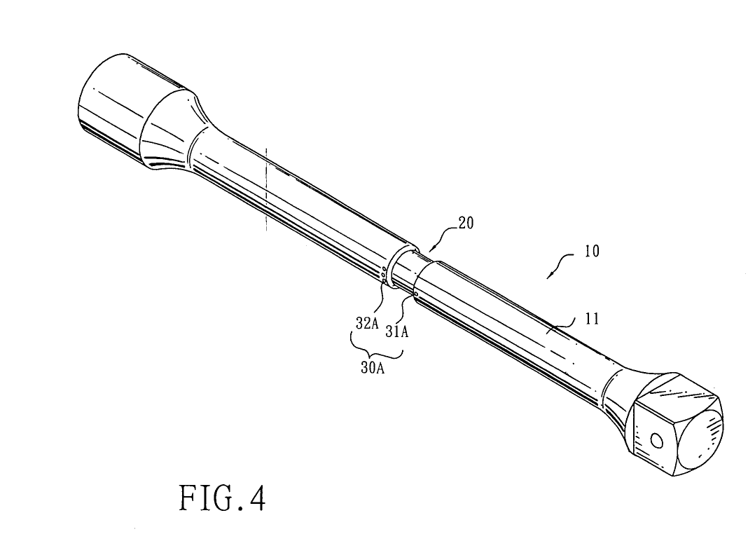

As shown in FIGS. 4 and 5, the body 11 of the present invention is provided with a stress monitoring structure comprising a stress intensity control portion (the recessed portion) 20, and a stress intensity monitor 30A which is formed of an indicator point 31A and a reference point 32A. The indicator point 31A is aligned with the reference point 32A, as shown in FIG. 5.

As illustrated in FIG. 6, the recessed portion 20 is caused to deform by a straining force exerting thereon, thereby resulting in nonalignment of the indicator point 31A with the reference point 32A. The nonalignment is indicative of an excessive stress produced in the body 11. In the event that the body 11 is not relieved of the excessive stress, a breakage is bound to take place in the stress intensity control portion 20.

The stress intensity monitor 30A is further formed of two warning points 33A which are opposite in location to each other and are located equidistantly from the reference point 32A such that the two warning points 33A and the reference point 32A are arranged in a straight line.

As soon as one of the two warning points 33A is aligned with the indicator point 31 A, the body 11 should be immediately relieved of the strain exerting thereon, so as to avert breakage of the body 11.

The embodiments of the present invention described above are to be regarded in all respects as being illustrative and nonrestrictive. Accordingly, the present invention may be embodied in other specific forms without deviating from the spirit thereof. The present invention is therefore to be limited only by the scopes of the following claims.

1. A pneumatic tool accessory having a body whereby said body is provided with a stress monitoring structure comprising a stress intensity control portion serving as a breaking point of said body, and a stress intensity monitor formed of a reference mark and an indicator mark, with said reference mark and said indicator mark being separated from each other by said stress intensity control portion such that said indicator mark is aligned with said reference mark, and that said indicator mark is nonaligned with said reference mark at such time when said stress intensity control portion is caused to deform by a straining force exerting on said body.

2. The pneumatic tool accessory as defined in claim 1, wherein said stress intensity monitor is further formed of two warning marks which are arranged at an interval from two opposite sides of said reference mark.

3. The pneumatic tool accessory as defined in claim 1, wherein said reference mark is a straight line; wherein said indicator mark is a straight line.

4. The pneumatic tool accessory as defined in claim 1, wherein said reference mark is a dot; wherein said indicator mark is a dot.
